(19) United States
(12) Patent Application Publication
(10) Pub. No.: US 2009/0009532 A1
(43) Pub. Date: Jan. 8, 2009

(54) VIDEO CONTENT IDENTIFICATION USING OCR

(75) Inventor: Bryan Severt Hallberg, Vancouver, WA (US)

Correspondence Address: MARGER JOHNSON & MCCOLLOM, P.C. - Sharp, 210 SW MORRISON STREET, SUITE 400, PORTLAND, OR, 97204, US

(73) Assignee: SHARP LABORATORIES OF AMERICA, INC., Camas, WA (US)

(21) Appl. No.: 11/772,758

(22) Filed: Jul. 2, 2007

(51) Int. Cl. G09G 5/00

(52) U.S. Cl. 345/636

(57) ABSTRACT

Systems and methods for processing video content to identify the video content including monitoring the video content for a video overlay added to the video content, identifying a video source of the video content in response to the video overlay, and identifying the video content in response to the video source.

### BACKGROUND

Televisions are commonly attached to a set-top-box (STB) to tune video content provided to the STB. Such an STB can be provided by a cable television service provider, a satellite television service provider, or the like. In such circumstances, the STB can be performing the tuning, not the television itself. As a result, the television does not know the channel of the current video source tuned by the STB. Even though the television may include a tuner itself, in this circumstance, the television is only used as a monitor.

Some video sources can have meta-data encoded in the video signal that may identify the video content. However, an STB often removes the meta-data from the video signal before providing it to a television. In addition, not all programs include such meta-data.

Unfortunately, in such circumstances the television cannot identify the video content that it is displaying. Accordingly, there remains a need for an improved video content identification in video processing systems.

### SUMMARY

An embodiment includes identifying video content including monitoring the video content for a video overlay added to the video content, identifying a video source of the video content in response to the video overlay, and identifying the video content in response to the video source.

Another embodiment includes receiving at least one video frame of video content from a video processing system, identifying a video overlay in the at least one video frame, identifying video overlay parameters for the video overlay, and transmitting the video overlay parameters to the video processing system.

### BRIEF DESCRIPTION OF THE DRAWINGS

FIG. 1 is a block diagram of a video processing system according to an embodiment.

FIG. 2 is an annotated video frame showing an example of video overlay parameters for content identification.

FIG. 3 is an exploded view of a portion of the image of FIG. 2 showing pixels for identifying a video overlay.

FIG. 4 is an annotated video frame showing another example of video overlay parameters for content identification.

FIG. 5 is an annotated image showing an example of multiple video overlay parameters for content identification.

FIG. 6 is an exploded view of a portion of the image of FIG. 2 showing a channel identification region.

FIG. 7 is an exploded view of a portion of the image of FIG. 4 showing a channel identification region.

FIG. 8 is an exploded view of a portion of the image of FIG. 2 showing examples of additional content information in a video overlay.

FIG. 9 includes exploded views of portions of the image of FIG. 8.

FIG. 10 is block diagram of a system for identifying video content according to an embodiment.

FIG. 11 is a flowchart showing identification of video content according to an embodiment.

FIG. 12 is a flowchart showing an example of monitoring for a video overlay in FIG. 11.

FIG. 13 is a flowchart showing an example of identifying a video source in FIG. 11.

FIG. 14 is a flowchart showing another example of monitoring for a video overlay in FIG. 11

FIG. 15 is a flowchart showing how additional content information is used in the identification of video content.

FIG. 16 is a flowchart showing an example of how a server is used in identifying video overlay parameters according to an embodiment.

FIG. 17 is a flowchart showing an example of how multiple video sources are used in identifying video overlay parameters according to an embodiment.

FIG. 18 is a flowchart showing an example of changing video content in identifying video overlay parameters according to an embodiment.

FIG. 19 is a flowchart showing an example of using a static region of the video content in identifying video overlay parameters according to an embodiment.

### DETAILED DESCRIPTION

Embodiments will be described with reference to the drawings. Embodiments can identify video content using information contained within a video overlay even if no meta-data, tuning information, or other content information is provided.

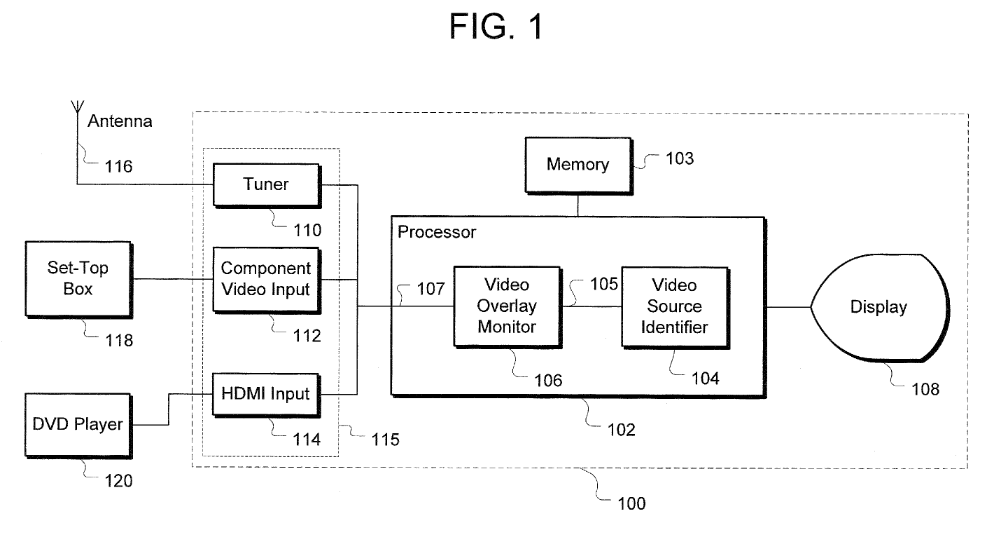

FIG. 1 is a block diagram of a video processing system 100 according to an embodiment. The video processing system 100 can be any device that can process a video signal. For example a video processing system 100 can be a television, monitor, projector, or the like. Alternatively, the video processing system 100 need not be capable of displaying video. For example, the video processing system 100 can be a device between a video source and a display. In another example, the video processing system 100 can be a digital video disk (DVD) player, a digital video recorder (DVR), or the like.

The video processing system 100 includes one or more video inputs 115. In this example, the video inputs 115 include a tuner 110, a component video input 112, and a high definition multimedia interface (HDMI) input 114. Other video inputs 115 can include a digital video (DVI) input, an RGB input, or the like. Any interface for communicating video can be used as a video input 115. The particular video inputs 115 are only used as examples.

Regardless of the type of video input 115, video content 107 is output from the video input 115. The video content 107 can include a video overlay. A video overlay is any additional video that is added to video content from the source of the video content. For example, a STB can receive a satellite broadcast of video content. The STB may be capable of providing an on screen guide with information on the video content. Such an onscreen guide is a video overlay. That is, it is added to the video content to be displayed.

Video overlays can include a variety of information related to the video content both directly and indirectly. For example, a video overlay can include the title, scheduled time, channel, description, or other information related to the video content. As described above, if such information was encoded in the video content an STB may removed it. However, the information can still be available through the video overlay.

In an embodiment, the video processing system 100 can use the video overlay to identify the video content. The video processing system 100 includes a processor 102 and memory 103. The processor 102 can be any device, apparatus, system, or the like capable of executing code. For example, a processor 102 can include general purpose processors, special purpose processors, application specific integrated circuits, programmable logic devices, distributed computing systems, or the like. In addition, the processor 102 may be any combination of such devices.

The memory 103 can be any variety of devices capable of storing data. For example, the memory 103 can include dynamic memory, static memory, flash memory, disk drives, internal devices, external devices, network attached storage, or the like. Any combination of such memories can be used as the memory 103.

The processor 102 is configured to monitor the video content 107 for a video overlay. Video overlay monitor 106 represents the processing to monitor the video content 107 for the video overlay. The video content 107 from the video input 115 is input to the video overlay monitor 106. The video content 107 can, but need not be the entire video content. For example, a reduced number of frames, such as every other frame, one frame per second, or the like can be provided as the video content 107 to the video overlay monitor 106.

In this embodiment, the video processing system 100 includes a display 108. The display 108 can display the video content 107. The video content displayed by the display 108 can, but need not be identical to the video content 107. For example, the video content 107 can be at a reduced frame rate while the displayed video content can be at the original frame rate.

From the video content 107, the video overlay monitor 106 can identify the video overlay. Once a video overlay is identified, the processor 102 is configured to identify a video source of the video content in response to the video overlay. Video source identifier 104 represents this processing.

A video source can include a STB, a DVD player, a videocassette recorder (VCR), a DVR, a broadcast signal received through an antenna, or the like. However, a video source can include granularity beyond a physical device providing the video content. For example, the video source can include the channel to which the STB is tuned, an angle of a DVD video, a particular video-on-demand (VOD) program, or the like.

Although video content may be input to the video processing system 100 from a physical device, the video source need not include an identification of that physical device. That is, in an embodiment, the video source identifier 104 may only identify a portion of a complete video source. For example, the identified video source may only be a channel number of an STB, and not an identification of the STB service provider. This does not mean that the identified video source cannot be combined with other information, For example, the STB service provider identity can be set in configuration parameters of the video processing system 100. The identified channel number in combination with the STB service provider may be used to identify the video content.

By identifying the video source, the video processing system 100 now has information with which it can obtain information related to the video content. For example, consider the situation where a user is watching channel 40 on an STB. The video processing system 100 can discover that the channel is 40 by identifying the video source from the video overlay. The STB information can also be discovered, or may have been previously input. In an embodiment, the video processing system 100 can access an electronic program guide (EPG) for the channels provided by the STB. Using the channel number 40 and other information, the video processing system 100 can now identify the video content and potentially obtain more information related to that video content.

As described above, a channel identification such as a channel number may be present in a video overlay. For example, an STB typically displays the channel identification in a video overlay whenever the user changes channels. The channel identification may also be displayed by the STB in the video overlay when the user presses a button such as “Info”. First, the video overlay monitor 106 can determine that a video overlay exists in the video content. To accomplish this, the video overlay monitor 106 can monitor the video content using video overlay parameters.

Video overlay parameters include aspects of video content that have an increased likelihood of indicating that a particular video overlay is present in the video content. For example, video overlay parameters can include areas of a video frame, pixels of a video frame, time-varying changes of such parameters, or the like.

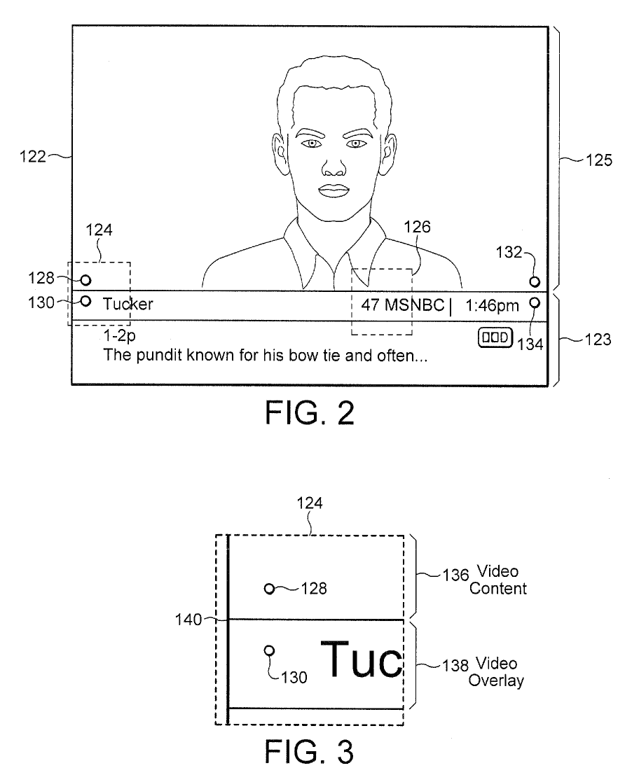

FIG. 2 is an annotated video frame 122 showing an example of video overlay parameters for content identification. Video frame 122 includes a video overlay 123. In this example, the video overlay 123 was added by an STB when a user pressed an “Info” button on a remote control for the STB. The video overlay 123 covers a bottom portion of the video frame 122. The video content is still visible in the upper portion 125.

In this example, the video overlay parameters include pixels 128, 130, 132, and 134. Pixels 130 and 134 are located within the video overlay 123. Pixels 128 and 132 are located outside of the video overlay 123 in the upper portion 125 of the video frame 122. While pixels 128 and 132 may have unknown values because the video content changes, pixels 130 and 134 should have known values, known ranges of values, or other known characteristics because they are within the video overlay 123.

In an embodiment, only one pixel need be checked to identify a video overlay. For example, only pixel 130 within the video overlay 123 can be checked. Pixel 130 can be compared with a video overlay color. If the pixel 130 is the video overlay color, or within some range of that color, then a video overlay can be identified. Accordingly, a very small amount of processing power is needed to monitor for the video overlay.

In another embodiment, to improve accuracy of the detection of a video overlay, additional pixels can be used. For example, pixel 128 can be used in conjunction with pixel 130. FIG. 3 is an exploded view of a portion of the image of FIG. 2 showing pixels for identifying a video overlay. FIG. 3 is region 124 of the video frame 122, including pixels 128 and 130. A division 140 separates the video content 126 and the video overlay 138 in the region 124. Division 140 is used for illustration and need not be part of the video overlay 138. Pixel 128 is above the division 140 in the video content 136. Pixel 130 is below division 140 in the video overlay 138.

Pixel 130 can be monitored for the video overlay color. However, if the video content without a video overlay happens to have that color in the region of pixel 130, a false identification may be made. Pixel 128 can be used to reduce the likelihood of a false identification. If the video content in the region of pixel 130 has the video overlay color and pixel 128 has a different color, the certainty that the video overlay is in the video content is increased. When the video overlay 138 is displayed, pixel 130 should have the color of the video overlay 138. In contrast, pixel 128 should not have the color of the video overlay 138.

Referring back to FIG. 2, in another embodiment, multiple locations on the video frame 122 can be checked to monitor for the video overlay 123. For example, pixels 132 and 134 can be used to monitor another location along the border of the video overlay 123 and the video content in the video frame 122. Similar to pixels 128 and 130, pixels 132 and 134 can be examined to monitor for the video overlay 123. The examinations of all of the pixels can be used to make a decision about the display of a video overlay 123. Accordingly, the video frame 122 can be examined along borders between the video overlay 123 and the video content 125.

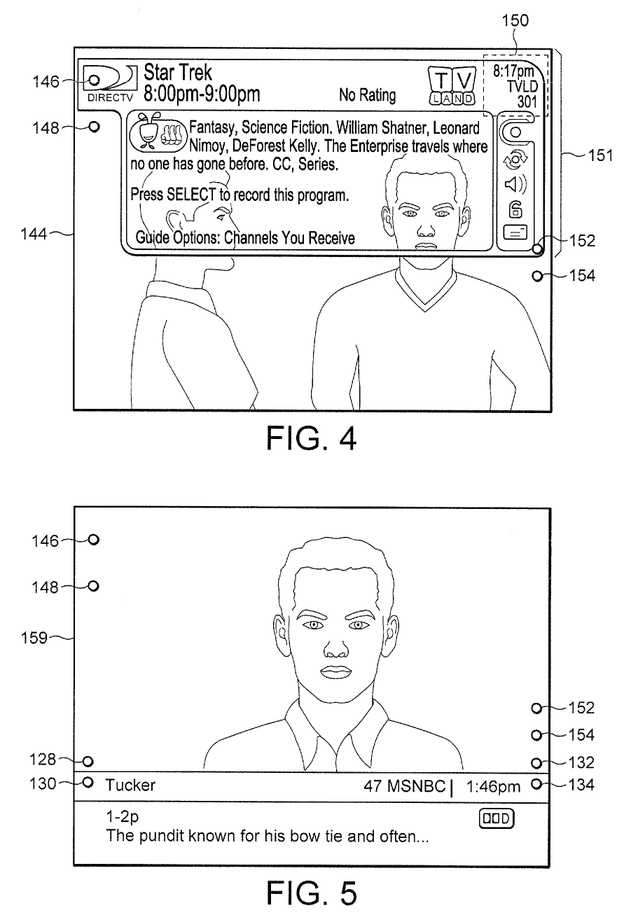

FIG. 4 is an annotated image showing another example of video overlay parameters for content identification. Video frame 144 illustrates a different video overlay 151. Pixels 146, 148, 152, and 154 are illustrated for monitoring the video frame 144 for the video overlay 151. In this example, pixels 146 and 152 are on the video overlay 151 in different locations. Pixel 146 is on a location of the video overlay with a logo for the service provider; however, pixel 152 is on a location of the video overlay where there is only the background color of the video overlay. As a result, when the video overlay is in video frame 144, pixels 146 and 152 can have different colors. Accordingly, each pixel within the video overlay can have its own video overlay color, independent of any other pixels.

FIG. 5 is an annotated image showing an example of multiple video overlay parameters for content identification. As can be seen the video frame 159 in FIG. 5 has pixels 128, 130, 132, and 134 from FIG. 3, and pixels 146, 148, 152, and 154 from FIG. 4. The processor 102 can monitor for some or all of these pixels of multiple video overlay parameters. In this example, the video overlay is the video overlay 123 of FIG. 3.

As described above, the video processing system 100 can receive multiple different video signals. Whenever a video overlay associated for a particular video signal is detected, processing specific to that video overlay can be performed. In particular, the further processing can, but need not be performed without knowledge of what video source is supply the currently displayed video signal.

Furthermore, a single physical video source, such as a STB, can have multiple different overlays for various situations. For example, a program guide, a quick information pop-up, a channel change overlay, or the like may each have both common and independent video overlay parameters.

Although using pixels that are both inside and outside of the video overlay 123 have been described the pixels used can all be within the video overlay 123. For example, the pixels 130 and 134 can be used. If both pixels have the video overlay color then it is likely that the video overlay 123 is displayed.

Although pixels have been illustrated in the drawings as having a particular size relative to a video frame, the pixels can, but need not be that particular size. The size of the illustration of the pixels was selected to identify the location of the pixel. However, this does not mean that multiple pixels cannot be used, particularly a number of pixels together having a relative size of an illustrated pixel. In contrast, as described above, multiple pixels can be within the same local region. These multiple pixels can be treated individually as described above, or can be combined together into a measurement through averaging, filtering, or the like.

Although a particular color has been described as being used to compare with a pixel, the pixel color can be compared with a range of colors. For example, two different STBs, even STBs from the same service provider, may display the same video overlay; however, the video overlay may be slightly different in the individual STBs due to processing variations, color space settings, or the like. Accordingly, the particular pixel can be compared against a range of colors. Furthermore, the range of colors can, but need not be limited to one color component, equivalent ranges of color components, or the like. Any region within any given color space can be used for a range of color of a pixel.

In an embodiment, a purpose for identifying a video overlay is to extract a channel identification from the video overlay. Detecting the video overlay before attempting to further identify the channel identification has multiple benefits. For example, detecting the video overlay as described above can be a very low processing power function. If the video processing system 100 were to try to determine the channel identification without first detecting the video overlay, then the video processing system 100 would need to run the channel identification function continuously, requiring more processing power.

In addition, by waiting for an identified video overlay, a number of false positives of channel identifications can be reduced. For example, other characters, images, or the like within a channel identification region of the video frame can be misinterpreted as a channel identification when the video overlay is not present.

As described above, video overlay parameters define aspects that can indicate if a video overlay is present in the video content. The locations of the pixels, the colors or color ranges to compare the pixels against, the number of frames over which to monitor for a video overlay, and the like are all possible video overlay parameters.

Video overlay parameters can be dependent on the settings of the video processing system 100. For example, the video processing system 100 can be a standard definition television having a resolution of 640×480 pixels. Accordingly, the video overlay parameters can be in terms of the video content at such a resolution. In contrast, the video processing system 100 can be a high definition television having a resolution of 1920×1080 pixels. The video overlay parameters can be in terms of that resolution.

In another example, the video processing system 100 may process the video content at a particular resolution regardless of the output resolution. In another example, the video processing system can process the video content at the resolution of the video content, regardless of the resolution for displaying video content. In one embodiment, the video overlay parameters can be generic and scaled to particular resolutions. In another embodiment, the video overlay parameters can have specific definitions for particular resolutions. Any combination of such video overlay parameters can be used and can be considered together to be the video overlay parameters for a given video overlay.

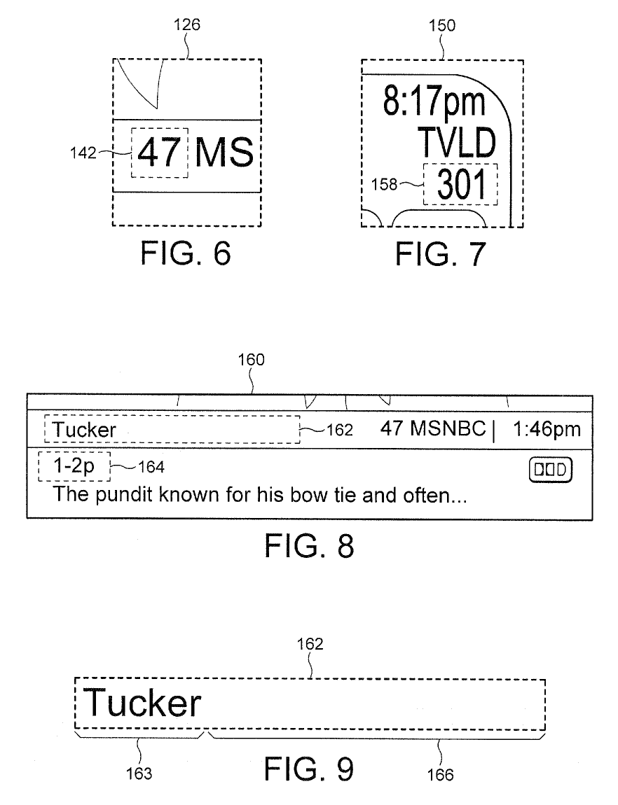

Once the video overlay is identified in the video content, a channel identification can be extracted from the video overlay for further processing. As described above, a channel number is an example of a channel identification. The channel number can be in a predictable location for each style of channel overlay. FIGS. 6 and 7 illustrate exploded views of regions in video frames for FIGS. 2 and 4, respectively. In FIG. 6, region 126 includes the channel number. In this example, the channel number is 47. Area 142 is an example of a channel identification area for the video overlay 123 of FIG. 2.

The channel identification area can be Cartesian coordinates for the area 142 containing the channel number. In an embodiment, the area 142 can be copied to an off screen buffer for further processing. Because the area 142 is small relative to the entire video frame 122 of FIG. 2, less processing can be used for copying. As a result, area 142 can be copied to the buffer with reduced concern for artifacts, frame skips, or the like visible to the user.

FIG. 7 illustrates another example of a channel identification area 158. This example was taken from the video overlay 151 in FIG. 4. Accordingly, each video overlay can have a unique channel area. The definitions of the channel identification area can be part of the video overlay parameters.

The video overlay may not always be in the same pixel location. In an embodiment, to improve the accuracy in locating the channel identification area, a set of pixels near the video overlay's edges can be sampled to locate the exact edge. Then, using the location and size of the video overlay, a more accurate prediction of the location and size of the channel identification area can be calculated. Accordingly, the video overlay parameters defining the channel identification area can be defined with greater precision, reducing the amount of processing used in processing the channel identification area.

Once located, a channel identification can be extracted from the channel identification area. Again, since the channel identification area is smaller than the area of the entire image, less processing is needed to extract the channel identification. In an embodiment, optical character recognition (OCR) can be used on the channel identification area. The OCR is performed only on the channel identification area. Accordingly, a reduced amount of processing is required.

In one embodiment, the OCR is performed only checking for the digits that can form a channel identification. For example, digits 0-9 only can be used. In another example, select characters such as a limited set of letters or punctuation, that may form the channel identification can also be used. In addition, the OCR can use font specific techniques. A given video overlay may use a particular font. The OCR can be customized to that font, increasing the accuracy of the OCR. In addition, a video overlay may use particular colors for the channel identification. The channel identification colors can be used as part of the OCR. The available characters, fonts, colors or the like can be part of the video overlay parameters. In addition, for different video overlays, different character sets, fonts, colors, or the like can be specified.

In an embodiment, the edge of the first character can be easily detected by starting at one end of the captured graphics and searching for the font color in any pixel of each pixel column, working toward the other end until a column is found with the font color. Then pattern matching can be performed. Character edge enhancement, frame averaging, noise reduction, equalization, emphasis, quantization, color space conversion, or other algorithms can be applied for more robustness.

FIG. 8 is an exploded view of a portion of the image of FIG. 2 showing examples of additional content information in a video overlay. Many video overlays also include the name of the current program, the station identification broadcast times, or other information associated with the video content. Similar to the channel identification, this other information can be located on the video overlay in a predictable location.

Accordingly, regions of the video overlay can be extracted from a video frame that corresponds to the locations of the additional information. FIG. 8 illustrates two examples of regions with additional information. Region 162 includes the title of the video content. Region 164 includes the broadcast time. Similar to the channel identification region, a particular region related to additional information can be extracted and OCR performed only on that region.

The broadcast time in region 164 is of interest when the video content is time-shifted. For example, the video content can be a recording on a personal video recorder (PVR). Since the video content can be viewed at a time later than the broadcast, the actual viewing time may not be correlated to the video content. Accordingly, using the viewing time may lead to erroneous identification of the video content. When retrieving information on the video content, the broadcast time can be used to further identify the video content.

In addition, similar to the channel identification described above, a limited set of characters can be used when using OCR on a broadcast time region 164. Since the broadcast time region may only include time related information, the character set can be limited to those found in representations of time, time spans, or the like. For example, 0-9, a, m, p, :, —, or the like can be used. Accordingly, a lower processing power OCR algorithm can be used.

FIG. 9 includes exploded views of portions of the image of FIG. 8. Region 162 with the video content title. In region 162, the text of the title occupies only a portion 163 of the entire region. Another portion 166 does not contain text. In an embodiment, the video overlay parameters specifying the title region 162 can define an area that is the entire expected area for the title. Having a region for the maximum expected text can be used not only for the video content title, but for any region extracted from the image.

In another embodiment, the video processing system 100 need not perform the OCR. The video processing system 100 can send the entire frame, the extracted region, or the like to a server 172. The server 172 can then perform OCR on the frame or region.

Although using pixels of the video content has been described as an example of how to identify a video overlay, other techniques can be used. For example, the video processing system 100 can could use other cues to determine if it is likely that the video source has changed channels. The video processing system 100 can detect an infrared (IR) signal sent to an STB. In another example, the video processing system 100 can detect discontinuities in the video input. These indicate that the STB's channel may have changed. When a channel changes on an STB, a video overlay can appear. Accordingly, the above described information can be extracted from the video overlay without having to process pixels of the video content.

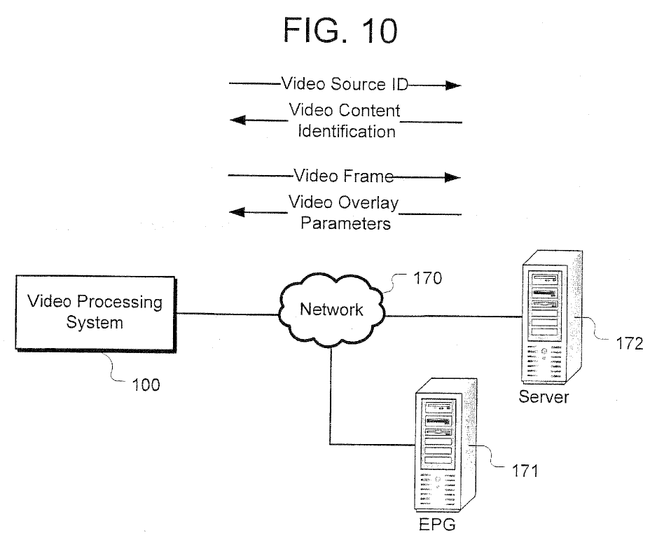

FIG. 10 is block diagram of a system for identifying video content according to an embodiment. The video processing system 100 is coupled to a network 170. A server 172 and an electronic program guide 171 (EPG) are also coupled to the network 170.

Once information regarding the video content is obtained, it can be used to identify the video content. For example, given the channel number, the video content can be readily identified. EPG web services, databases, or the like, can be accessed by the video processing system 100, either directly or via an intermediate server, to identify the video content.

As described above, a video source can be a channel identification. In an embodiment, the channel identification, the service provider, the location of the video processing system 100, the current time, or the like can be used to determine the content. As described above, the channel identification can be extracted from a video overlay. Accordingly, the channel identification can be sent from the video processing system 100 to the server 172. An identification of the video content can be received from the server 172.

In an embodiment, a user can specify other parameters in the video processing system 100. For example, the user can select their service provider from a setup menu. In another example, such information could be detected using the user's location, the list of MSOs serving that area, and the channel banner shape. The location of the video processing system 100 can be determined at setup time by the user entering their zip code, or automatically by examining the video processing system 100 IP address. The current time may be known by the server. Accordingly, with such information, a video content identification can be sent to the video processing system 100.

In an embodiment, the video content identifications can be cached in the video processing system 100. As a result, when the STB changes channels back to a previously viewed channel, the video processing system 100 does not need to access the server again to identify the same content. The EPG 171 can specify the program's start and end times, and the video processing system 100 can use those values to determine if it should access the server to retrieve the identity of a newly started program if the current program has completed. Accordingly, processing related to video content identification can be further reduced,

In an embodiment, video overlay parameters can be set by having a user select a video source from a set of known video sources. For example, the video processing system 100 can store multiple video overlay parameters for multiple STBs. The user can select the model of their particular STB from a menu of the known STBs. Accordingly, the video processing system 100 can identify the video overlay parameters to use when monitoring the video content.

Alternatively, the video processing system 100 need not store all or any of the known video overlay parameters. A user can select an STB from a menu. The video processing system 100 can then request the video overlay parameters from the server 172 for the user's particular STB.

In an embodiment the video processing system 100 can capture one or more video frames containing a video overlay. The video frames can be sent to the server 172 for analysis. The server 172 can compare the captured video overlay against known video overlays to determine the video overlay parameters for the particular STB. The video overlay parameters for the particular STB can then be sent to the video processing system 100.

In an embodiment, the capturing could occur during an initial setup operation. For example, the video processing system 100 can request the user to cycle through channels on the STB. In another example, the video processing system 100 can request the user to press a remote control button to bring up the video overlay. In another example, the video processing system 100 can detect when large areas of the screen contain a static image, which happens when the channel banner is displayed. Accordingly, once a frame has been identified as having a video overlay, the video frame can be sent to the server 172 for the corresponding video overlay parameters.

In an embodiment, if the event that video overlay parameters are not available, a static image detection algorithm can be used. Captured video frames can be analyzed to determine what portion of the frames does not change. For example, while having a user change channels, one or more video frames can be captured. As the user changes channels, a video overlay can indicate information regarding the current channel. If a video frame is captured for each channel change, a common feature of the video frames can be the presence of a video overlay. Since the shape of the video overlay will not likely change, the static area corresponds to the video overlay shape.

With the determined shape, the video overlay parameters can be selected to identify when the video overlay is present. For example, if an edge of the video overlay is discovered, video overlay parameters describing pixels on either side of the edge can be created. As described above, pixels on either side of the edge can be checked to identify the video overlay in the video processing system 100. In addition, the video overlay color, color range, or the like can be determined from the static image. The color parameters can be added to the video overlay parameters.

In an embodiment, the video frames can be analyzed for a channel identification region. For example, where the user has changed the channel on an STB, the resulting video overlays in the captured frames will have a common area where the current channel is displayed. An OCR algorithm can be performed on the video frames.

The channel identification area can be distinguished for a variety of reasons. For example, it is an area of the video overlay which contains only numbers, a reduced character set, or the like. In addition, the expected numbers are limited to numbers for available channels. For example, cable and satellite service providers may only have channel numbers between 1 and 999. Accordingly, if a region has numbers outside of that range, then that region is not likely to be a channel identification area. In an embodiment, particular characters can be excluded from a channel identification. For example, a channel identification may not contain a colon, yet a time of day may contain a colon. Accordingly, if the area contains a colon, it may not be a channel identification are.

In another embodiment, the user can be instructed to increase or decrease the channel on the STB. As a result, the characters in the channel identification area would be changing monotonically, whether increasing or decreasing. As used in this description, a monotonic change can include a change in the opposite direction, so long as subsequent changes are in the expected direction. For example, if a user is at the highest channel and presses a channel up button, the channel can wrap-around to the lowest channel. Such a change can still be seen as monotonic. Furthermore, monotonic can include changes to alternate numbering schemes. For example, after reaching a maximum channel number on an STB having a video on demand (VOD) capability, subsequent channels may be labeled as VOD1, VOD2, VOD3, etc., cycling through the VOD channels. Accordingly, the shift to another numbering scheme can still be considered monotonic since within that scheme the changes occur in one direction.

Although particular examples of how to distinguish a channel identification area have been described above other criteria can be used. Any characteristic of the channel identification that increases the certainty that a given area is a channel identification area can be used as criteria.

Once the channel identification area is determined, location parameters, color, font size, or the like can be added to the video overlay parameters. Accordingly, when a video overlay is identified, the channel identification area can be extracted as described above..

In an embodiment, this OCR algorithm can be a higher processing power or higher complexity algorithm. Since this algorithm may only be performed initially, such as in a setup of the video processing system 100. Accordingly, any increased processing time would not adversely impact the other operations described above.

Although the determination of the video overlay parameters has been described above as being performed by the video processing system 100 or a server 172, any combination of processing to determine the video overlay parameters can be divided among the video processing system 100 and the server 172.

Regardless of how the video overlay parameters are generated the server 172 can update the video overlay parameters on the video processing system 100. For example, an MSO may introduce a new video overlay interface through an update to the MSO's STBs. Accordingly, the updated video overlay parameters for the new video overlay can be sent from server 172 to the video processing system 100. In another embodiment, the video overlay parameters can be determined anew as described above.

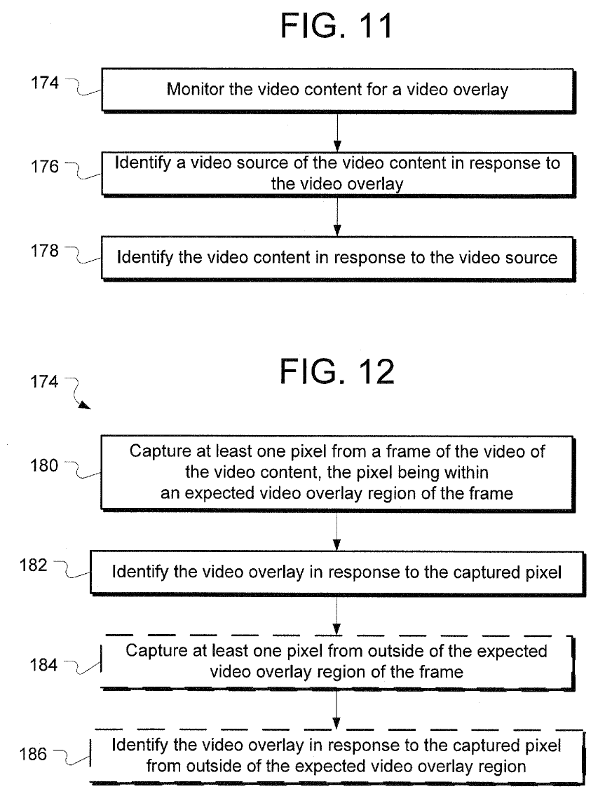

FIG. 11 is a flowchart showing identification of video content according to an embodiment. An embodiment includes a method of identifying video content including monitoring the video content for a video overlay in 174, identifying a video source of the video content in response to the video overlay in 176, and identifying the video content in response to the video source in 178.

Monitoring the video content for the video overlay in 174 includes any technique of determining if a video overlay is present. As described above, pixels of a video frame, controls of an STB, or the like can be used to determine if a video overlay is present in the video content.

Identifying a video source of the video content in response to the video overlay in 176 includes any technique of extracting an identification of the video source from the video overlay. As described above, video overlay parameters can be used for extracting a channel identification or other video source from the video overlay.

Identifying the video content in response to the video source in 178 includes any technique of determining what the video content is using the identified video source. As described above, an EPG can be accessed using the video source to determine the video content. In another example a server can store video content information. Identifying the video content information can include accessing the server and indicating the identified video source. Accessing any database, storage, memory, or the like that has video content information can be part of identifying the video content in 178.

FIG. 12 is a flowchart showing an example of monitoring for a video overlay in FIG. 11. In an embodiment, monitoring the video content for the video overlay in 174 includes capturing at least one pixel from a frame of the video of the video content in 180, and identifying the video overlay in response to the captured pixel in 182. In this embodiment, the pixel is within an expected video overlay region of the frame.

Capturing at least one pixel from the frame includes extracting a pixel at any point in processing of a frame. For example, the frame can, but need not be from a complete frame. Capturing of the at least one pixel can be performed at a variety of intervals. For example, a pixel from every frame can be captured. Alternatively, a pixel from one frame per second can be captured. An embodiment can include any interval that decreases processing considering the time span of an expected video overlay.

Once a pixel is captured, it can be used to identify the video overlay in 182. In an example described above, if the pixel has the video overlay color, and is in an expected video overlay region of the frame, it is likely that the video overlay is present. The comparison of a pixel to the video overlay color can result in identification of the video overlay.

As described above, additional pixels can be used in monitoring for a video overlay. Thus, in an embodiment monitoring the video content for the video overlay includes capturing at least one pixel from outside of the expected video overlay region of the frame, and identifying the video overlay in response to the captured pixel from outside of the expected video overlay region. In an embodiment, the pixel within the expected video overlay region of the frame and the pixel from outside the expected video overlay region are divided by an edge of the video overlay.

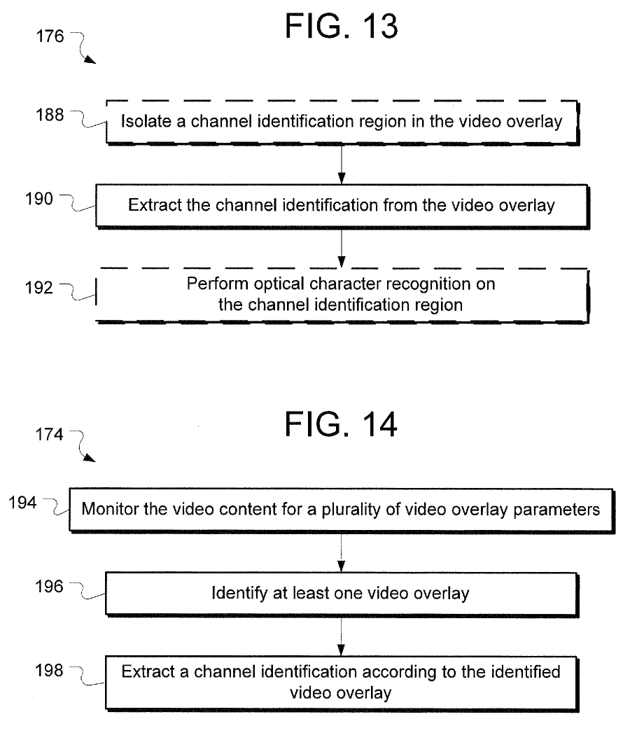

FIG. 13 is a flowchart showing an example of identifying a video source 176 in FIG. 11. In an embodiment, a channel identification can be a video source. Accordingly the channel identification can be extracted from the video overlay in 176. As described above, a channel identification is an identification of a channel that is providing the video content.

In an embodiment, a channel identification region can be isolated in the video overlay in 188. Isolating the channel identification region includes any technique of controlling access to just the channel identification region. For example, the channel identification region can be copied from a source video frame into a buffer. In another example, the access to the channel identification region can be indexed into the source video frame itself. In this example, isolating the channel identification region can include setting the parameters for the access into the source frame such that only the channel identification region is accessed.

Once the channel identification region is isolated in 188, the channel identification can be extracted from the isolated channel identification region in 190 as described above. Since the channel identification region has been isolated from the frame, only that region needs to be processed. Accordingly, less processing power is needed than if the entire frame was processed.

In an embodiment, OCR can be performed on the channel identification region in 192. As described above, the OCR can be performed with a reduced character set, such as only 0, 1, 2, 3, 4, 5, 6, 7, 8, 9, period, or the like.

FIG. 14 is a flowchart showing another example of monitoring for a video overlay in 174 in FIG. 11. In an embodiment, the video content can be monitored for a plurality of video overlay parameters in 194. As described above, multiple video sources can be providing video to the same video processing system. Each can have their own video overlay. Accordingly, the video content can be monitored for any of these video overlays. In one example, the monitoring for the multiple video overlays can be performed substantially simultaneously. Pixels for each of the video overlays can be examined at the same time. In another example, monitoring for individual video overlays can be interleaved. The monitoring for the video overlays can be ordered as desired. Regardless of how the video content is monitored, at least one video overlay is identified in 196. Once identified, the channel identification is extracted according to the identified video overlay in 198.

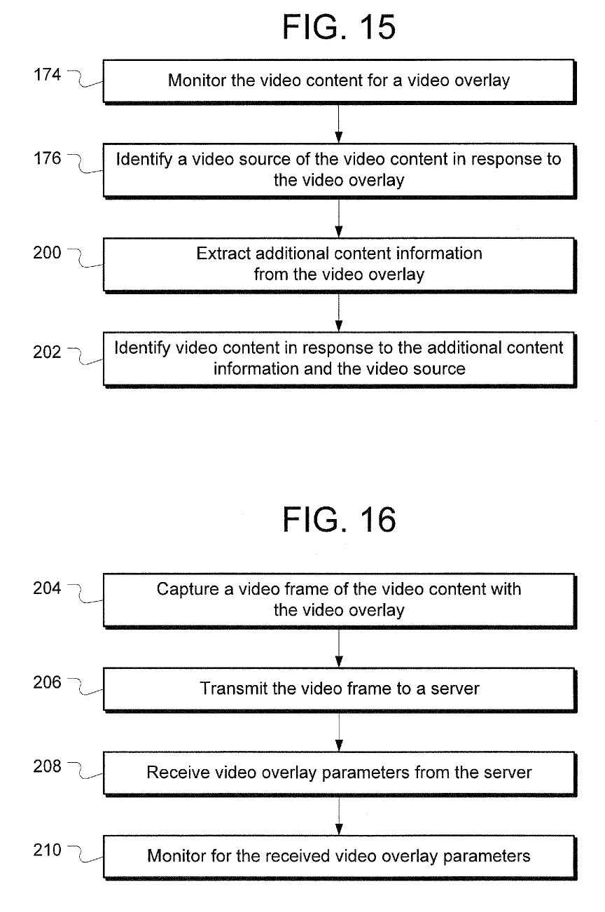

FIG. 15 is a flowchart showing how additional content information is used in the identification of a video source of video content. In an embodiment additional content information can be extracted from the video overlay in 200. As described above, a video overlay can have additional content information such as title, description, broadcast time, or the like. All or any of this additional content information can be extracted from the video overlay. Once the additional content information is extracted, the video content can be identified in response to both the additional content information and the video source in 202.

FIG. 16 is a flowchart showing an example of how a server is used in identifying video overlay parameters according to an embodiment. As described above, a server can be used to obtain the video overlay parameters. In an embodiment, a video frame of the video content with the video overlay is captured in 204. The captured video frame is transmitted to a server in 206. Any variety of communications links can couple a video processing system to a server. For example, an Ethernet connection, a Wi-Fi connection, a fiber-optic connection, a cable modem, or the like.

In an embodiment, the server may not be able to make a determination on one video frame. Accordingly, the before the server can transmit the video overlay parameters, additional frames may need to be transmitted to the server. Once the server has identified the video overlay from the frames, the video overlay parameters can be received from the server in 208. Accordingly, the video content can be monitored for the received video overlay parameters in 210.

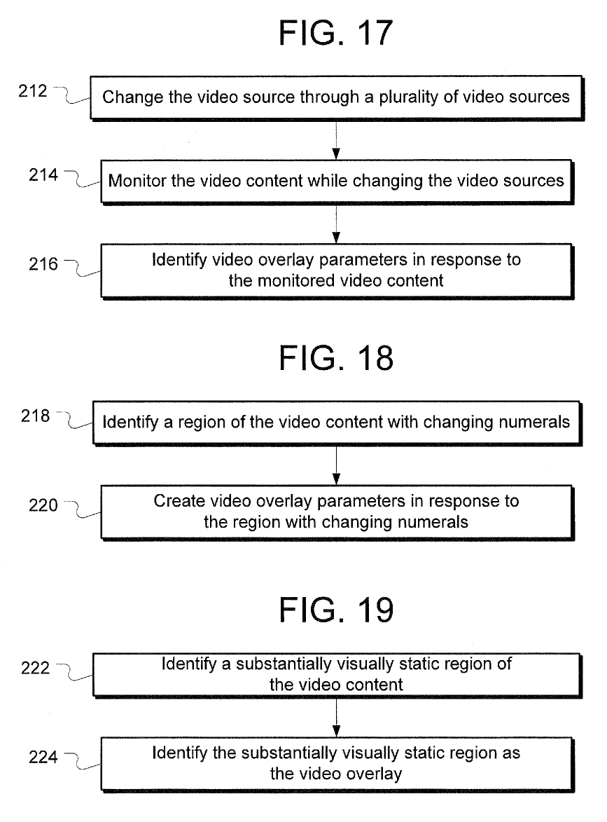

FIG. 17 is a flowchart showing an example of how multiple video sources are used in identifying video overlay parameters. In an embodiment, the video source is changed through a plurality of video sources in 212. The video content is monitored while changing the video sources in 214. As described above, changing a video source can cause the video source to display a video overlay. Any video overlay that appears can be monitored.

Once the video content is monitored, video overlay parameters can be identified in response to the monitored video content in 216. Identifying the video overlay parameters can, but need not include generating or deriving the video overlay parameters. As described above, if a particular STB is not known, the video overlay parameters can be generated by examining static regions, changing regions, or the like in the video content. Thus, identifying the video overlay parameters can include generating the video overlay parameters from the static region, changing region, or the like.

In an embodiment, the STB may be known. Identifying the video overlay parameters can include identifying a STB from the monitored video content and selecting the video overlay parameters for that STB. Any combination of such identification of the video overlay parameters can be used. For example, the monitored video content can identify an STB for some video overlay parameters and more video overlay parameters can be generated from the monitored video content.

FIG. 18 is a flowchart showing an example of changing video content in identifying video overlay parameters. In an embodiment, a region of the video content with changing numerals is identified in 218. As described above, such a region can be a channel identification region. Accordingly, video overlay parameters can be created in response to the region with changing numerals in 220.

FIG. 19 is a flowchart showing an example of using a static region of the video content in identifying video overlay parameters. In an embodiment, a substantially visually static region of the video content can be identified in 222. A substantially visually static region is a region of the video content where the video content is not changing significantly from frame to frame.

A substantially static region can be substantially static for a limited period of time. For example, a video overlay may be present in the video content for two seconds. Although for a time period longer than two second the region of the video content containing the video overlay may not be substantially static, for the time period that the video overlay is present, that region can be considered substantially static.

The substantially static region can have portions within it that are changing. For example, a video overlay can have an animated icon, a preview of some video content, or other non-static portions. However, portions of the video overlay, such as a border, frame, or other bounding graphics, can remain static. The region that is substantially static can include the entire video overlay.

Furthermore, there may be some variation in the substantially static region. Variations in decoding, reception, processing, or the like of the video content can introduce variations in a video overlay. Substantially static can include these variations. Thus, a substantially static region need not be strictly static for color, size, location, or the like. For example, a region of a video overlay can have a particular color. However, through decoding for presentation on a particular display, the color may vary within a range. If the color remains within that range, it can be considered substantially static. Once the substantially visually static region has been identified, it can be identified as the video overlay in 224.

An embodiment can include means for performing any of the above described operations. Examples of such means include the devices described above. Although the term device has been used to give examples of the means described above, device can include any system, apparatus, configuration, or the like.

Another embodiment includes an article of machine readable code embodied on a machine readable medium that when executed, causes the machine to perform any of the above described operations. As used here, a machine is any device that can execute code. Microprocessors, programmable logic devices, multiprocessor systems, digital signal processors, personal computers, or the like are all examples of such a machine.

Although particular embodiments have been described, it will be appreciated that the principles of the invention are not limited to those embodiments. Variations and modifications may be made without departing from the principles of the invention as set forth in the following claims.

1. A method of identifying video content, comprising:
monitoring the video content for a video overlay;
identifying a video source of the video content in response to the video overlay; and
identifying the video content in response to the video source.

2. The method of claim 1, further comprising:
capturing at least one pixel from a frame of the video of the video content, the pixel being within an expected video overlay region of the frame; and
identifying the video overlay in response to the captured pixel.

3. The method of claim 2, further comprising:
capturing at least one pixel from outside of the expected video overlay region of the frame; and
identifying the video overlay in response to the captured pixel from outside of the expected video overlay region.

4. The method of claim 3, in which:
the pixel within the expected video overlay region of the frame and the pixel from outside the expected video overlay region are divided by an edge of the video overlay.

5. The method of claim 1, further comprising:
extracting a channel identification from the video overlay.

6. The method of claim 5, further comprising:
transmitting the channel identification to a server; and
receiving an identification of the video content from the server.

7. The method of claim 1, further comprising:
isolating a channel identification region in the video overlay; and
extracting the channel identification from the isolated channel identification region.

8. The method of claim 7, further comprising:
performing optical character recognition on the channel identification region.

9. The method of claim 7, further comprising:
performing optical character recognition on the channel identification using only 0, 1, 2, 3, 4, 5, 6, 7, 8, 9, and period.

10. The method of claim 1, further comprising:
monitoring the video content for a plurality of video overlay parameters;
identifying at least one video overlay; and
extracting a channel identification according to the identified video overlay.

11. The method of claim 1, further comprising:
extracting additional content information from the video overlay; and
identifying the video content in response to the isolated content information and the video source.

12. The method of claim 1, further comprising:
capturing a video frame of the video content with the video overlay;
transmitting the video frame to a server;
receiving video overlay parameters from the server;
monitoring for the received video overlay parameters.

13. The method of claim 1, further comprising:
changing the video source through a plurality of video sources;
monitoring the video content while changing the video sources; and
identifying video overlay parameters in response to the monitored video content.

14. The method of claim 1, further comprising:
identifying a region of the video content with changing numerals;
creating video overlay parameters in response to the region with changing numerals.

15. The method of claim 1, further comprising:
identifying a substantially visually static region of the video content;
identifying the substantially visually static region as the video overlay.

16. A video processing system, comprising:
a memory; and
at least one processor configured to:
monitor the video content for a video overlay;
identify a video source of the video content in response to the video overlay; and
identify the video content in response to the video source.

17. The video processing system of claim 16, in which the at least one processor is further configured to:
isolate a channel identification region in the video overlay; and
extract the channel identification from the isolated channel identification region.

18. The video processing system of claim 16, in which the at least one processor is further configured to:
capture at least one pixel from a frame of the video of the video content, the pixel being within an expected video overlay region of the frame; and
identify the video overlay in response to the captured pixel.

19. The video processing system of claim 16, in which the at least one processor is further configured to:
capture at least one pixel from outside of the expected video overlay region of the frame; and
identify the banner in response to the comparison.

20. A system for processing video content received in a video processing system, the system comprising:
a memory; and
at least one processor configured to:
receive at least one video frame of the video content from the video processing system;
identify a video overlay in the at least one video frame;
identify video overlay parameters for the video overlay; and
transmit the video overlay parameters to the video processing system.

21. The system of claim 20, wherein the at least one processor is further configured to:
receive a plurality of video frames of the video content from the video processing system;
identify a substantially static region in the video frames; and
generate video overlay parameters in response to the substantially static region.

22. The system of claim 20, wherein the at least one processor is further configured to:
receive a plurality of video frames of the video content from the video processing system, at least one of the video frames having a channel identification different from at least one of the other video frames;
identifying a channel identification area in response to the video frames; and
generating video overlay parameters in response to the channel identification area.
